(19) United States
(12) Patent Application Publication
(10) Pub. No.: US 2013/0285412 A1
(43) Pub. Date: Oct. 31, 2013

(54) System for Protecting Vertical Interior Columns of Automobile from Burns and The Like

(71) Applicant: Shawn P. McCarthy, Union City, NJ (US)

(72) Inventor: Shawn P. McCarthy, Union City, NJ (US)

(21) Appl. No.: 13/847,274

(22) Filed: Mar. 19, 2013

Related U.S. Application Data
(60) Provisional application No. 61/612,555, filed on Mar. 19, 2012.

(51) Int. Cl. B60R 13/08

(52) U.S. Cl. CPC B60R 13/0815
USPC 296/181.6

(57) ABSTRACT

The inventive burn-guard for an interior car column includes the combination of a variable length clasp adapted for secure engagement, at two or more transverse locations, upon an interior column of an automobile, and a protective covering proportioned to simulate a factory-provided vertical column such that the clasp and covering in cooperate to protect selected vertical interior columns of an automobile from damage of various types. The system may be sold as a kit of its individual parts namely, the adjustable clasp and the column cover or they may be sold separately on a “mix-and-match” basis.

### FIELD OF INVENTION

The present invention relates to a system and method for the provision of fire and other protection to vertical interior columns within the passenger compartment of an automobile.

### BACKGROUND OF THE INVENTION

Vehicles are currently provided with some degrees of heat (and noise) insulation. Such insulation however is generally limited to the interior of the sides or doors of the automobile as well, in some cases, to the engine area itself. Such prior art is reflected in U.S. Pat. No. 6,712,316 (2004) to Jones, entitled Snap-Wall Assembly; U.S. Patent Application Publication US 2009/0026787 (2009) to Mueller et al, entitled Insulation Structure for the Internal Insulation of a Vehicle; and U.S. Patent Publication 062263 to Cropper, entitled Use of Ceramic Fiber Barriers in Vehicle Compartments.

In other words, snap-on sidewall assemblies, as is taught above in Jones, are available to provide fire-resistance in a vehicle including an aircraft, however, is not relevant to the needs of passenger vehicles in which the vertical columns within the interior thereof are often subject to cigarette burns and damage caused by children in the normal course of wear and tear on a car. The interior surface of some vehicles is simply that of cloth or leather which, as is known, is highly susceptible to cigarette burns.

Some of the concepts of Jones also appear in said patent publication to Cropper, these however are only relative to generalized insulation of the passenger compartments in the event of extreme heat from the outside of the vehicle. The reference to Muller is particular to an insulation structure usable only as interior insulation within walls and the like of a vehicle.

Accordingly, there does not exist in the art a method or system by which a fire retardant or scratch resistant covering can easily be applied to the parts of the interior compartment of a vehicle that are particularly susceptible to burns, typically from cigarettes, scratching, defacing and the like by children within the vehicle,

The present invention therefore addresses his long-felt need in the art.

### SUMMARY OF THE INVENTION

The inventive system comprises the combination of a variable length clasp adapted for secure engagement, at two or more transverse locations, upon an interior column of an automobile, and a protective covering proportioned and designed to simulate a factory-provided vertical column such that said clasp and covering in combination serve to protect selected vertical interior columns of an automobile from damage of various types as set forth above. The present system may be sold as a kit of its individual parts thereof, namely, the adjustable clasp and the column cover or the parts may be sold separately on a “mix-and-match” basis.

It is an object of the invention to provide a protective system for interior vertical columns of automobiles and the like.

It is another object to provide a kit for the accomplishment of the above objects.

It is a further object to provide a system of the above type that may be easily installed and removed.

The above and yet other objects and advantages of the present invention will become apparent from the hereinafter set forth Brief Description of the Drawings, Detailed Description of the Invention and Claims appended herewith.

### BRIEF DESCRIPTION OF THE DRAWINGS

Shown in FIG. 1 is a perspective view of an interior of a vehicle to be provided with the present inventive burn and damage protective vertical column covering for interior vehicle columns.

FIG. 2 is an exploded view showing a column to be protected, and an inventive clasps and cover associated with the present system.

FIG. 3 is a plan view taken along Line 3-3 of FIG. 2.

FIG. 4 is an enlarged operational view of the right hand side of he clasp shown in the center of the exploded view of FIG. 2,

FIG. 5 is a representational view of a burn or fire resistant covering in accordance with the present invention.

### DETAILED DESCRIPTION OF THE INVENTION

With reference to the perspective view of FIG. 1, there may be seen the front interior portion of the driver side of a typical automotive vehicle. In the general use of a vehicle, cigarette burns and other damages to vertical columns 10 of the inside of the vehicle are common. Whether such damage is caused by cigarette burns, the activity of children within the car, or other reasons, the end result is to reduce the value of the car and, in the event of leased vehicles, to increase the charges to the lessee (vehicle user) at the time the vehicle is returned. The instant invention therefore addresses the protection of both front and side interior columns from damage from such causes and which may, if desired, be removed from the car following the expiration of a lease or the sale of the automobile.

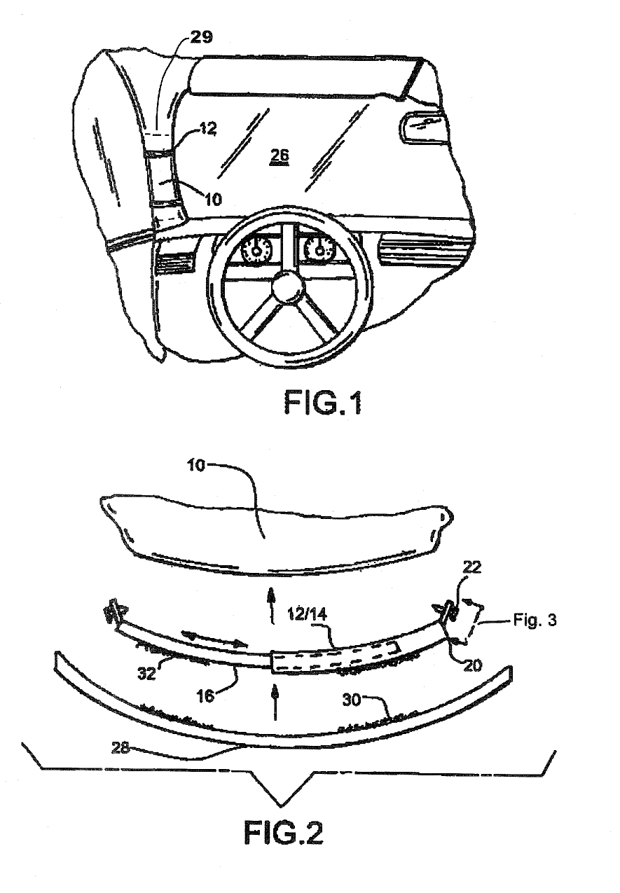

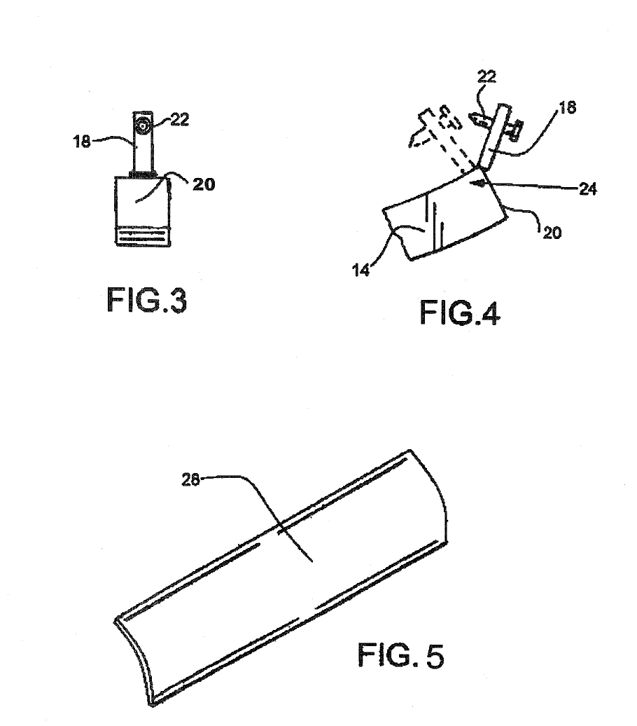

in FIG. 1 is therefore shown the interior column 10 which is representative of the interior front and side column of any vehicle which the user of the present invention wishes to protect from cigarette burns or other damages above set forth. A cross-section of column 10 is also shown in the exploded view of FIG. 2. Further shown in FIG. 1 is an adjustable clasp 12, shown in more detail in FIG. 2, which is attachable to the vertical column to be protected. In phantom lines 29 are shown the position of protective cover 28, described below. As may be noted in FIG. 2, clasp 12 is characterized by telescoping portions 14 and 16 in which portion 16 may be selectably slid within or withdrawn from hollow portion 14 of clasp 12. In order to secure clasp 12 upon vertical column 10, there are provided fasteners 18 or the like (see FIG. 3) at area 24 which are pivotally attached to outer portion 20 of clasp 12. Fasteners 18 are provided with a plastic set screw 22 or the like in which the fastener may be pivotally advanced about pivot area 24 such that a sharpened tip of screw 22, when slidably advanced within fastener 18 may engage at the side or rear of column 10 between the column and the windshield 26 of the automobile. Accordingly, through such slidable advance, clasp 12 is secured to one side of the vertical column 10.

Shown outwardly of clasp 12 in FIG. 2 is a substantially ovoid segment 28 of fire resistant material which, when secured to clamp 12 through the use of male and female VELCRO 30 and 32 respectively, secures cover 28 in a stable semi-permanent fashion relative to column 10, as shown by phantom lines 29 in FIG. 1. Through the provision of male VELCRO 30 upon the inner surface of cover segment 28 and female VELCRO 32 upon the outer surface of clasp 12, cover 28 may be selectably changed in accordance with the preferences of a car owner or user, for example, to include selectable graphics or affinity related information, e.g., related to a sporting or other organization. It is to be appreciated that the length of fire resistant cover 28 may considerably exceed the distance between the placement of clasps 12 and may exceed that shown in FIG. 1, and its curvature may exceed that shown in FIG. 5. The present system may be sold as a kit of its individual parts thereof, namely, the adjustable clasp and the column cover or the parts may be sold separately on a “mix-and-match” basis.

While there has been shown and described above the preferred embodiment of the instant invention it is to be appreciated that the invention may be embodied otherwise than is herein specifically shown and described and that, within said embodiment, certain changes may be made in the form and arrangement of the parts without departing from the underlying ideas or principles of this invention as set forth in the Claims appended herewith.

I claim:

1. A system for the provision of a fire and impact resistance surface to vertical interior columns of an automobile or the like, the system comprising:
(a) at least one adjustable clasp comprising an elongate male element proportioned for friction-fit telescoping within a hollow female receiving element, said clasp further having (i) a first end at a free end of said male element, said end provided with screw and fastening means, and (ii) a second end at a free end of said female element, provided with screw and fastening means, each of said screw and fastening means proportioned for selectable engagement between an auto windshield and at least one of said interior columns, said clasp including VELCRO or the like adhered to surfaces, of both of said male and female elements, opposite to said columns; and
(b) a simulation of at least one of said interior columns having VELCRO or the like, complemental to said VELCRO adhered to said adjustable clasp, adhered to an interior surface of said column simulation at axial locations opposite to locations of said at least one of said clasps upon said at least one of said interior columns.

2. The system as recited in claim 1, in which said simulation comprises:
a shell defined by about one longitudinal half of an ovoidal surface.
